(19) United States
(12) Patent Application Publication
(10) Pub. No.: US 2025/0178061 A1
(43) Pub. Date: Jun. 5, 2025

(54) DEVICE AND SYSTEM FOR LAYING AND INSERTING VARIABLE HOLES IN IRRIGATION TUBING

(71) Applicant: Mississippi State University, Mississippi State, MS (US)

(72) Inventor: John Wesley Lowe, Houston, MS (US)

(73) Assignee: Mississippi State University, Mississippi State, MS (US)

(21) Appl. No.: 18/968,389

(22) Filed: Dec. 4, 2024

Related U.S. Application Data
(60) Provisional application No. 63/605,768, filed on Dec. 4, 2023.

(51) Int. Cl. B21D 28/28; B21D 28/34; B21D 28/36

(52) U.S. Cl. CPC B21D 28/28; B21D 28/34; B21D 28/36

(57) ABSTRACT

The present disclosure provides an improved device and system that punches holes in irrigation tubing in a continuous process with the ability to vary hole spacing based on locational needs and deposits the punched tubing into a trough created within the soil. The system of the present disclosure is configured to adjust the location and size of the holes as they are punched in the irrigation tubing based on data obtained from Computerized Hole Section (CHS) prescriptions and real-time GPS location data. The system is also configured to create a curved trough in the soil and place the punched tubing therein.

### CROSS-REFERENCE TO RELATED APPLICATIONS

This application claims the benefit of and priority to U.S. Provisional Application No. 63/605,768, filed on Dec. 4, 2023, and entitled “Device and System for Laying and Inserting Variable Holes in Irrigation Tubing,” the disclosure of which is expressly incorporated by reference in its entirety.

### TECHNICAL FIELD

The present disclosure relates generally to lay-flat irrigation tubing, and more particularly, to a device and system for deploying irrigation tubing in the field while selectively inserting holes in the tubing.

### BACKGROUND

Furrow irrigation is a method of irrigating fields used mostly for row crops (such as cotton, maize, soybeans, and sugar cane). In furrow irrigation, water flows down in evenly spaced furrows or corrugates running through the crops. Water is released directly into each furrow, running down the furrow's length and seeping into the soil at the root level. Generally, water is supplied to the furrows using lay-flat polyethylene irrigation tubing. Computerized Hole Selection (CHS) is the use of a computer program to design the appropriate number and size of holes to punch in the lay-flat irrigation tubing. The computer program is used to iterate the proper hole size along the tube/pipe so that water is distributed evenly across the field. CHS determines the correct hole size for each individual furrow in a lay-flat irrigation pipe system by accounting for row length, inlet and required individual furrow flow, pipeline pressure and hydraulics, and crown elevation. In furrow irrigation, a small hole punch device with sizes ranging from one quarter inch to one inch, with hole sizes for every 1/16 inch are used to create the holes in the pipe.

One of the most challenging and labor-intensive components of using CHS in lay-flat irrigation tubing is the proper insertion of holes into the tubing. This is a multi-step process in which the lay-flat tubing is attached to the riser and a person manually installs each hole by punching the correctly sized holes, using the correctly sized cutting die or hole punch, into the inflated tubing, creating an opening from which water flows into the furrows. CHS punch lists, which correspond to a planned flow prescription for the field and designate how many holes of a size should be punched in succession before swapping to another size, are utilized to determine the correct die size for each hole across the entirety of the tubing.

This current methodology presents many opportunities for errors to occur including, for instance, utilizing the wrong size die to punch holes, miscounting the number of holes of a particular size, and utilizing the wrong hole prescription or plan in a field. Additionally, the CHS software is often constrained to utilizing only certain sized holes to simplify the hole punch prescription, rendering the prescription simpler to implement, but not as detailed and with the potential to over or under-apply water across the field. These errors can negatively affect irrigation efficiencies and/or render the tubing effectively useless for delivering the desired amount of water.

Moreover, producers who adopt the use of prescriptive hole sizing in lay-flat irrigation tubing are faced with challenges in laying the tubing in the fields. The tubing must be delivered or laid in the field along the highest points of elevation, allowing the slope of the field to direct and channel the flow and provide the vehicle for water coverage and distribution. Laying of the irrigation tubing is a labor-intensive process as each of the rolls of irrigation tubing must be loaded by hand onto implements and strategically unrolled along row ends in the field. Additionally, the tubing must be manually connected to risers, jointed together when materials are not long enough to reach in a single run, and fitted through appliances that monitor and control water flows such as surge valves and flow meters. Moreover, most paths for the tubing are plowed to have a flat bottom. It has been found that the flat bottom of the plowed path made correctly positioning the tubing a challenge when unrolled, leading to the polyethylene irrigation tubing twisting or rolling during inflation and being misdirected from the intended target, which necessitates adjustment to tubing positioning prior to charging with water for inflation.

Accordingly, there remains a need in the art for an improved mechanism for precise hole sizing and deployment of lay-flat irrigation tubing that more accurately meet water needs for improved crop efficiencies and yields.

### SUMMARY

The problems expounded above, as well as others, are addressed by the following inventions, although it is to be understood that not every embodiment of the inventions described herein will address each of the problems described above.

In some embodiments, a device for punching holes in irrigation tubing is provided, the device including a die assembly including a top roller and a bottom roller, each roller having spaced parallel axes of rotation, a die mounted on the bottom roller, wherein the die is circular or semi-circular and configured to punch a circular or semi-circular hole in the irrigation tubing, and a drive member for powering continuous rotation of the bottom roller. In one embodiment, the device further includes a surface positioned above the bottom roller, the surface including an opening vertically aligned with the die. In another embodiment, the device further includes a carriage device operatively connected to the die assembly and configured to horizontally slide the bottom roller to varying distances under the opening. In yet another embodiment, the circular hole has a diameter of about 13/16 inch to about 7 inches. In still another embodiment, the drive member is an electrical motor controlled by a controller.

In further embodiments, a device for punching holes in irrigation tubing is provided, the device including a frame including a mount attached thereto, the mount configured to support a roll of wound irrigation tubing; a die assembly attached to the frame, the die assembly including a top roller and a bottom roller, each roller having spaced parallel axes of rotation, and a die mounted on the bottom roller, wherein the die is shaped as a circle or semi-circle and configured to punch a circular or semi-circular hole in a folded seam of the irrigation tubing; a plurality of rollers positioned on each side of the die assembly and extending laterally across the frame; and a drive member for powering continuous rotation of the bottom roller. In one embodiment, the die assembly further includes a surface positioned above the bottom roller, the surface including an opening vertically aligned with the die. In another embodiment, the die assembly further includes a slidable carriage device operatively connected to the die assembly and configured to horizontally slide the bottom roller to varying distances under the opening. In still another embodiment, the device further includes a sensor operatively connected to the die assembly and configured to measure and monitor an edge of the irrigation tubing as holes are continuously punched therein. In yet another embodiment, the at least one roller includes a first guide roller attached thereto at a first end and a second guide roller attached thereto at a second end. In still another embodiment, the surface further includes a guide rail extending laterally across the surface and configured to flatten the irrigation tubing against the surface.

In still further embodiments, a system for punching holes in irrigation tubing and laying the punched irrigation tubing is provided, the system including the device for punching holes in irrigation tubing according to the embodiment described above, a placement device for laying the punched irrigation tubing including a rotary cutting device operatively connected to a hydraulic motor, the rotary cutting device including a rotor having a plurality of blades supported thereon, wherein the rotary cutting device is configured to cut a substantially curved trough for placement of the punched irrigation tubing; at least one sensor positioned in proximity to the device for punching holes and the placement device; and a controller communicatively coupled to the device for punching holes, the placement device, and the at least one sensor, wherein the controller is configured to perform at least one of the following: receive and communicate data from a Computerized Hole Section (CHS) prescription to the device for punching holes and, in response, adjust the size of a hole to be punched in the irrigation tubing, receive and communicate data from the at least one sensor to the device for punching holes and, in response, adjust a location of a hole to be punched in the irrigation tubing, or receive and communicate data from the at least one sensor to the placement device and, in response, adjust at least one or both of a horizontal position and a vertical position of the rotary cutting device.

In one embodiment, the system may further include a transport implement having the device for punching holes and the placement device attached thereto. In another embodiment, the at least one sensor includes a global positioning system (GPS) and the controller is configured to receive data from the GPS. In still another embodiment, the controller includes a computing device having a memory. In yet another embodiment, the memory stores the data from the CHS prescription. In another embodiment, the controller is configured to receive and communicate data from the at least one sensor to the device for punching holes, and in response, adjust the timing of the holes to be punched in the irrigation tubing. In still another embodiment, the rotary cutting device is a rotary ditcher head.

### BRIEF DESCRIPTION OF THE DRAWINGS

Further features and advantages can be ascertained from the following detailed description that is provided in connection with the drawings described below:

FIG. 1 is a front perspective view of a hole insertion device according to one embodiment of the present disclosure.

FIG. 1A is a side view of a tension brake for use with the hole insertion device according to one embodiment.

FIG. 1B is a front perspective view of the tension brake of FIG. 1A.

FIG. 2 is a top perspective view of a rotary die assembly according to one embodiment of the present disclosure.

FIG. 2A is a front perspective view of the rotary die assembly according to one embodiment of the present disclosure.

FIG. 2B is a cross sectional view of the rotary die assembly shown in FIG. 2A.

FIG. 2C is a perspective view of a roller guide according to one embodiment of the present disclosure.

FIG. 3 is a perspective view of a hole punch die according to one embodiment of the present disclosure.

FIG. 4A is a perspective view of a carriage device for use with the rotary die assembly according to one embodiment of the present disclosure.

FIG. 4B is a front view of the carriage device shown in FIG. 4A.

FIG. 5 is a perspective view of the rotary die assembly with a sensor according to one embodiment of the present disclosure.

FIG. 6 is a perspective view of the rotary die assembly with a guide rail according to one embodiment of the present disclosure.

FIG. 7A is a front view of a placement device according to one embodiment of the present disclosure.

FIG. 7B is a side view of the placement device shown in FIG. 7A.

FIG. 8 is a schematic diagram of one embodiment of a system of the present disclosure, including the hole insertion device and the placement device.

FIG. 9 is a schematic diagram of a computing device according to one embodiment of the present disclosure.

### DETAILED DESCRIPTION

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terms “about” and “approximately” shall generally mean an acceptable degree of error or variation for the quantity measured given the nature or precision of the measurements. Numerical quantities given in this description are approximate unless stated otherwise, meaning that the term “about” or “approximately” can be inferred when not expressly stated.

The terminology used herein is for the purpose of describing particular embodiments only and is not intended to be limiting. As used herein, the singular forms “a”, “an” and “the” are intended to include the plural (i.e., “at least one”) forms as well, unless the context clearly indicates otherwise.

The terms “first,” “second,” “third,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

Spatially relative terms, such as “above,” “under,” “below,” “lower,” “over,” “upper,” and the like, may be used herein for ease of description to describe one element or feature's relationship to another when the apparatus is right side up as shown in the accompanying drawings.

The term “substantially” allows for deviations from the descriptor that do not negatively impact the intended purpose. Descriptive terms are understood to be modified by the term “substantially” even if the word “substantially” is not explicitly recited.

It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

The present disclosure provides an improved device and system that inserts holes in irrigation tubing in a continuous process with the ability to vary hole spacing based on locational needs and deposits the punched tubing into a trough created within the soil. The hole insertion device of the present disclosure advantageously inserts correctly sized holes into the tubing in a continuous process during initial pipe deployment, eliminating the need for holes to be manually punched in a secondary step during initial pipe inflation for irrigation. Additionally, the hole insertion device allows for precise hole sizing due to its' ability to be infinitely adjusted within its' range of operation, creating the ability to optimize hole size relative to pressures within the tubing, row length, soil type, elevation, and other factors to optimize water application during irrigation events. The placement device of the present disclosure prevents the tubing from twisting or rolling as it inflates, keeping the pre-punched holes oriented in the correct direction relative to the desired discharge into the field. The present disclosure positively contributes to water conservation by eliminating any over-application and potential yield increases through adequate water application.

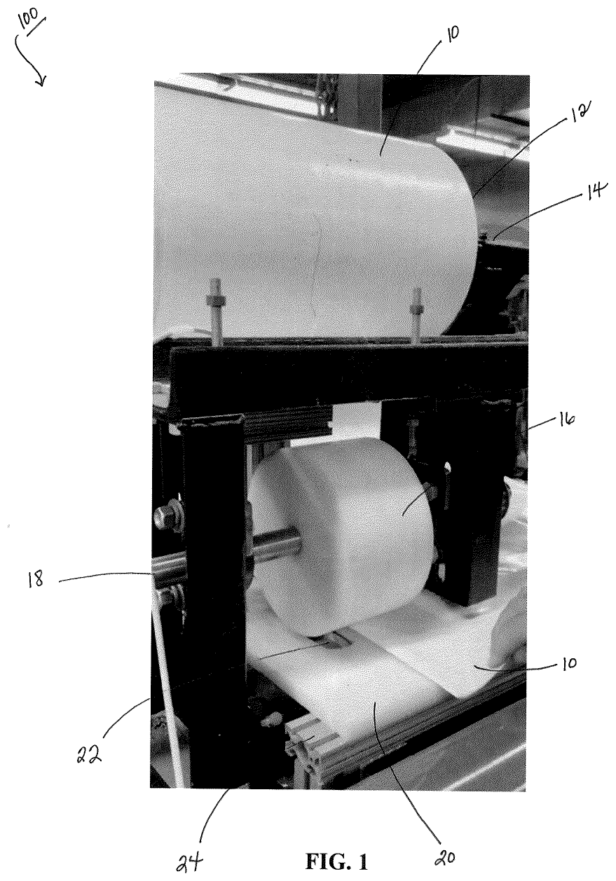

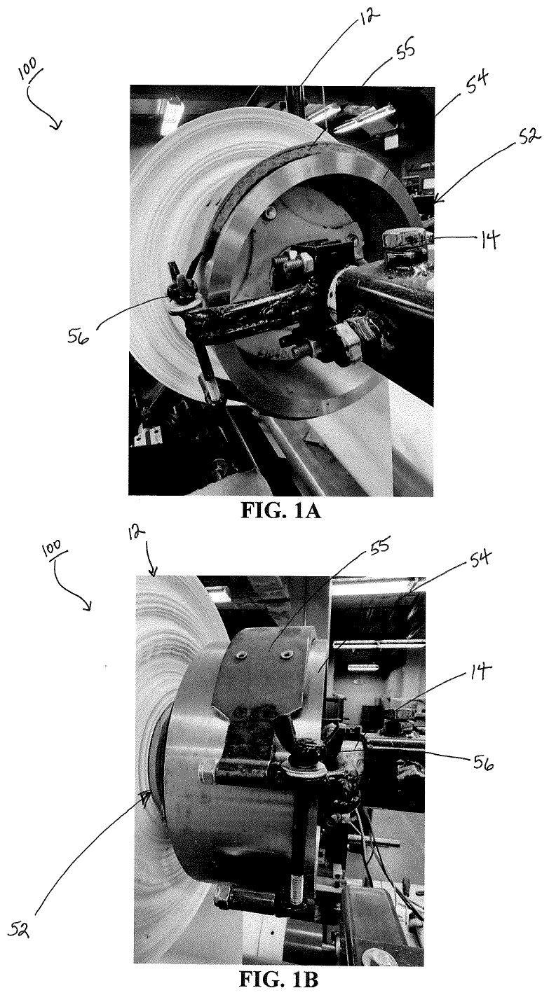

Referring to FIG. 1, a hole insertion device 100 according to one embodiment of the present disclosure is shown. The hole insertion device 100 is configured for inserting variable holes in the irrigation tubing in a continuous manner, as would be required during in-field deployment of the tubing. As will be described in greater detail below, the hole insertion device 100 is configured to selectively insert holes in irrigation tubing based on data from CHS prescriptions and GPS such that, when the tubing is laid and filled with water, the tubing expands, and water is accurately distributed to the fields through the numerous holes in the walls of the tubing.

As shown in FIG. 1, the hole insertion device 100 includes a spiral tubing roll 12 on which the irrigation tubing 10 is wound around an axle tube 14. In some embodiments, the irrigation tubing 10 is flexible polyethylene (PE) tubing, for example, poly pipe. In this embodiment, the poly pipe is generally flattened. In another embodiment, the irrigation tubing 10 may be polyvinyl chloride (PVC) tubing. The hole insertion device 100 is intended for use with irrigation tubing for furrow irrigation. However, as will be apparent to those of ordinary skill in the art, the hole insertion device 100 may also be used with tubing for other types of irrigation, such as drip irrigation, multiple inlet rice irrigation (MIRI), or irrigation for gardens.

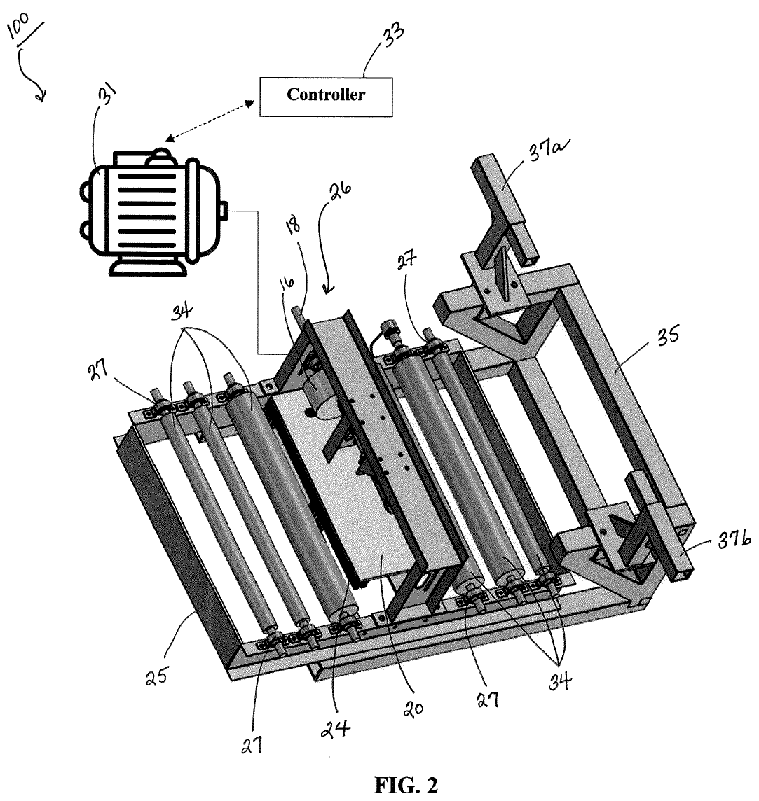

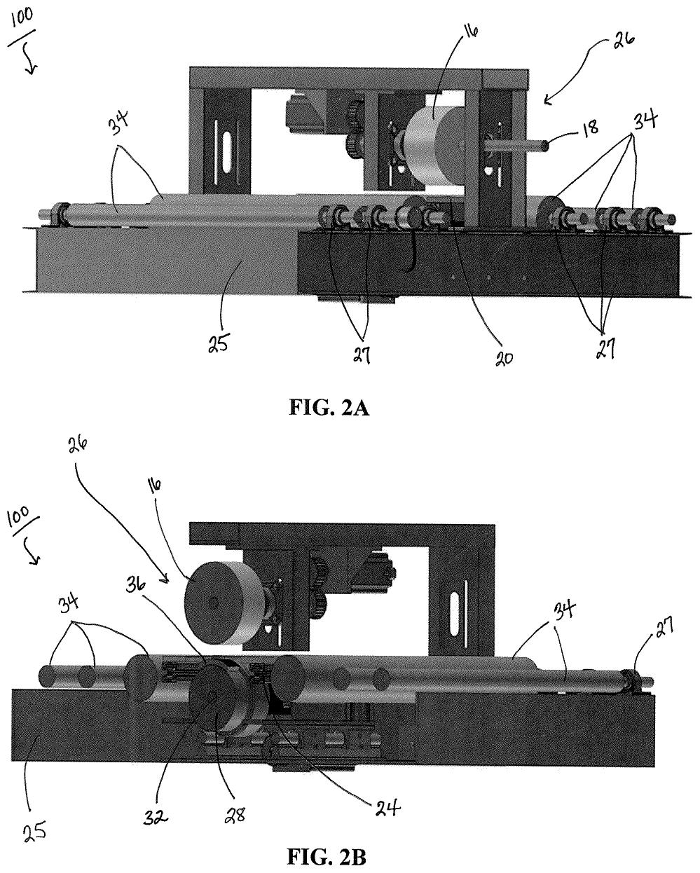

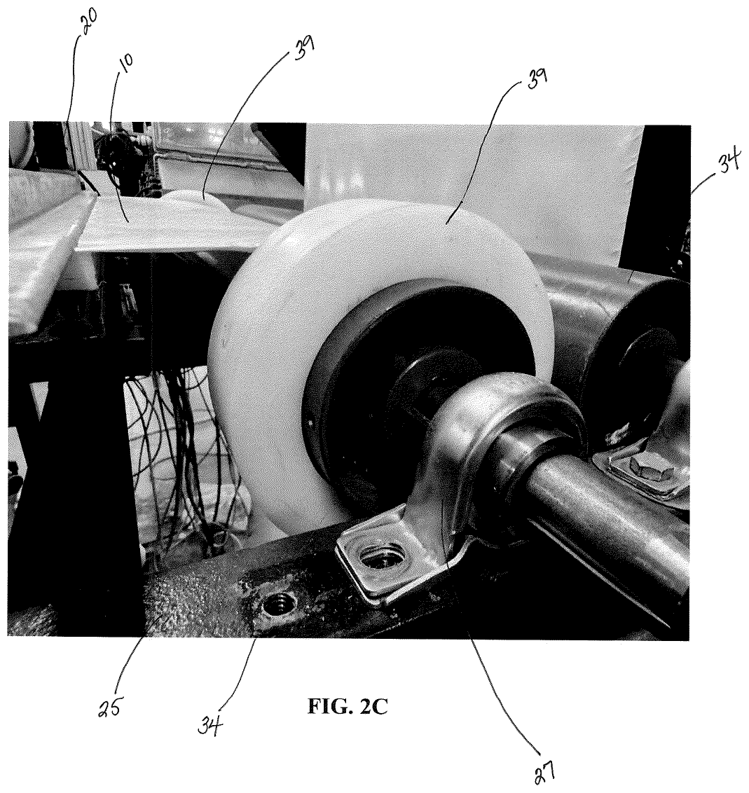

The spiral tubing roll 12 is configured to unroll the wound irrigation tubing 10 so that holes can be punched in the irrigation tubing 10 in a continuous manner using a rotary die assembly 26, shown in FIGS. 2-2B. A guide roller 16 is positioned adjacent to the spiral tubing roll 12 and is configured to direct the irrigation tubing 10 as it unrolls. The guide roller 16 is mounted on a cylindrical roller 18. The irrigation tubing 10 is directed in between the guide roller 16 and a base 20. The base 20 acts as a surface on which the tubing 10 can be supported when holes are being punched therein. The base 20 has an opening 22 that is vertically aligned with a hole punch mechanism on the rotary die assembly 26. As will be described in greater detail below, the hole punch mechanism punches holes in the tubing 10 through the opening 22.

FIGS. 1A and 1B show a tension brake 52 for use with the hole insertion device 100 according to one embodiment. As shown in FIGS. 1A and 1B, the hole insertion device 100 may include a tension brake 52 configured to increase the tension of the wound tubing roll 12 as it unrolls. The tension brake 52 is operatively connected to the axle tube 14 and configured to add tension to the tubing roll 12 so that the tubing roll 12 does not free spool and cluster in front of the rotary die assembly 26. The tension brake 52 includes a cylindrical roller 54 attached to the axle tube 14 and a lever 55 in contact with an outer portion of the cylindrical roller 54. The lever 55 can apply pressure to the cylindrical roller 54 (and hence, the tubing roll 12) by the tightening of a screw 56 operatively connected to the lever 55. The pressure added to the tubing roll 12 can be used to control the unrolling of the irrigation tubing 10 such that the unrolling is uniformly relative to the speed of the hole punch mechanism as it punches holes in the irrigation tubing 10.

FIGS. 2, 2A, and 2B show the hole insertion device 100 with a rotary die assembly 26 according to one embodiment of the present disclosure. As shown in FIG. 2, the hole insertion device 100 may include a mount 35 attached to the rotary die assembly 26. The mount 35 is configured to support the spiral tubing roll 12. Two brackets 37a, 37b may extend upwardly from the mount 35 to hold the spiral tubing roll 12 in an elevated position for unrolling. Each end of the axle tube 14 can be inserted onto the brackets 37a, 37b.

The rotary die assembly 26 can be secured to a base frame 25 that is attached to the mount 35. The rotary die assembly 26 also includes a plurality of rollers 34 spaced adjacent to the base 20 and supported on the base frame 25. The rollers 34 assist with moving and directing the irrigation tubing 10 as the holes are punched therein. In one embodiment, as shown in FIG. 2, the rollers 34 can be attached to the base frame 25 with a plurality of strap clamps 27. In the illustrated embodiment, the rollers 34 are cylindrical in shape. The diameters of each of the rollers 34 may vary, as illustrated in FIG. 2. For instance, the rollers 34 positioned directly adjacent to the base 20 may have a larger diameter than the other rollers 34 supported on the base frame 25. There are six rollers 34 illustrated in FIGS. 2-2C; however, as will be appreciated by those skilled in the art, any number of rollers 34 may be used so long as the rollers 34 can move and direct the irrigation tubing 10 through the rotary die assembly 26.

In some embodiments, as shown in FIG. 2C, one or more of the rollers 34 can include a roller guide 39 attached thereto to help maintain positioning of the irrigation tubing 10 and ensure the irrigation tubing 10 is fed through the hole insertion device 100 squarely. The roller guide 39 is a cylindrical member having a hole passing therethrough. The roller 34 can be inserted through the hole in the roller guide 39. In some embodiments, as illustrated in FIG. 2C, the roller 34 includes two roller guides 39, one on each end of the roller 34. In this embodiment, the roller guides 39 ensure that the irrigation tubing 10 is positioned squarely therebetween as it is fed to the rotary die assembly. In one embodiment, the roller guides 39 are added to the roller 34 positioned closest to (and directly adjacent to) the base 20. In further embodiments, other rollers 34 positioned on the rotary die assembly 26 can also include one or more of the roller guides 39.

The rotary die assembly 26 also includes the guide roller 16 and a die 36 mounted on a bottom cylindrical roller 28 configured for rotation on axle 32. As the irrigation tubing 10 is fed through the hole insertion device 100, the die 36 on the bottom roller 28 is configured to rotate and punch through the opening 22 on the base 20 to create a hole in an edge of the irrigation tubing 10. The guide roller 16 is “sacrificial” and provides a hard surface for the die 36 to act against as the tubing 10 is cut.

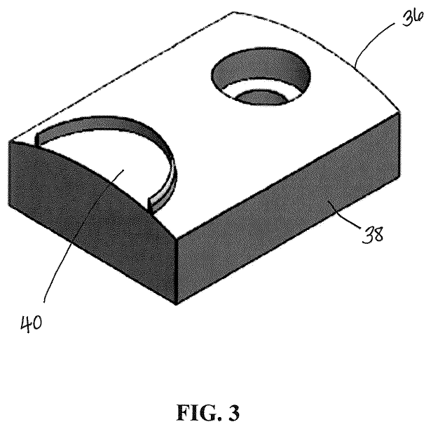

As shown in FIG. 3, the die 36 has a die body 38 of a generally rectangular shape and has a cutting die 40 shaped to cut out an opening in the irrigation tubing 10. In the illustrated embodiment, the cutting die 40 may be semi-circular. In this embodiment, the cutting die 40 can punch a semi-circular hole in the irrigation tubing 10. For instance, the cutting die 40 can be used to make a semi-circular cut in the folded seam of the irrigation tubing 10 such that when the irrigation tubing 10 is unfolded, a full circular hole is punched in the tubing 10. In another embodiment, the cutting die 40 is configured to punch a circular opening in the tubing 10. For example, the cutting die 40 can be circular shaped. The hole insertion device 100 provides cleanly punched holes (i.e., having no sharp or jagged edges) in the irrigation tubing 10. These holes provide a uniform flow that remains consistent between holes of the same size in the tubing, irrespective of material thickness. The hole insertion device 100 is also advantageous for inserting holes into the folded seam of the tubing 10 without leaving rough edges or hanging material that impedes the discharge of water. This removes any inconsistencies in flow and the resultant noise observed in the data from holes created utilizing prior art methods, such as the Poly Piranha insertion method.

In another embodiment of the present disclosure, the die 36 may include a matched set of dies, for instance, a punch and die combination, to cut holes in a similar manner as described above. In still another embodiment, the present disclosure contemplates the use of a “flying cutoff” method of hole insertion. Flying dies are dies that are made to move linearly along tracks built into a press. In this embodiment, the punch and die combination matches the linear speed of the tubing 10 as it punches the hole and then returns to the starting position to await the next hole position.

The size of the hole inserted by the hole insertion device 100 is dependent upon the size of the selected die. In some embodiments, the die 36 may be selected such that the hole insertion device 100 can insert holes having a circular diameter ranging in size from about 3/16 inch up to about 10 inches. In one embodiment, the die 36 may be selected such that the hole insertion device 100 can insert holes having a circular diameter ranging in size from about 7/16 inch to about 9 inches. In another embodiment, the die 36 may be selected such that the hole insertion device 100 can insert holes having a circular diameter ranging in size from about ½ inch to about 8 inches. In still another embodiment, the die 36 may be selected such that the hole insertion device 100 can insert holes having a circular diameter ranging in size from 9/16 inch to about 7 inches. In yet another embodiment, the die 36 may be selected such that the hole insertion device 100 can insert holes having a circular diameter ranging in size from 13/16 inch to about 1 inch. In one embodiment, the die 36 may have a diameter of about 13/16 inch, allowing for infinite adjustments in hole size between zero and 13/16 inch. In still further embodiments, the hole insertion device 100 can insert holes having a circular diameter of ⅛, 3/16, ¼, 5/16, ⅜, 7/16, ½, 9/16, ⅝, 11/16, ¾, 13/16, 1, 2, 3, 4, 5, 6, 7, 8, 9, or 10 inches. In one embodiment, the die 36 may be selected such that the hole insertion device 100 can insert holes having a circular diameter of about 7 inches. This embodiment allows for row spacing (e.g., linear distance between holes) of 22 inches and greater, which accommodates common row spacing used in most Mid-South farming practices.

The rotary die assembly 26 may be operatively connected to a carriage device 24. The carriage device 24 is configured to move the rotary die assembly 26 to varying distances in a horizontal direction to allow different sized holes to be punched in the irrigation tubing 10. The carriage device 24 may include a sliding mechanism that allows it to move the hole punch die 36 horizontally under the opening 22 to vary the size of the hole that is punched in the irrigation tubing 10 as it passes through the hole insertion device 100.

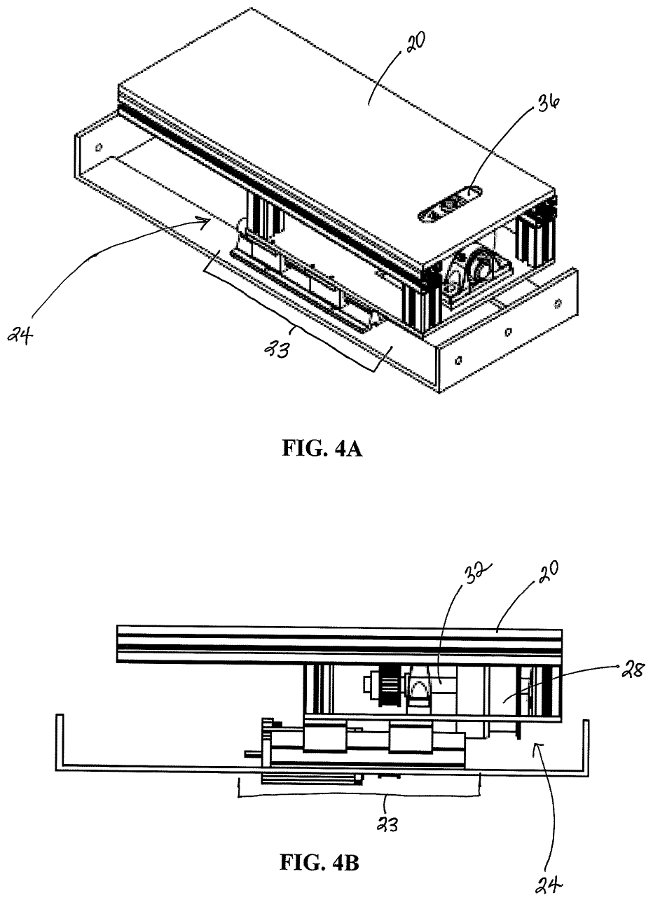

FIGS. 4A and 4B show the carriage device 24 according to one embodiment of the present disclosure. As shown in FIGS. 4A and 4B, the carriage device 24 is attached below the base 20. The carriage device 24 includes a sliding mechanism 23 operatively connected to the bottom roller 28 having the hole punch die 36 attached thereto. The sliding mechanism 23 is configured to move the bottom roller 28, and hence, the hole punch die 36, to varying horizontal distances to adjust the size of the hole to be punched. The rotary die assembly 26 and the carriage device 24 attached thereto allow for discrete and precise adjustment of hole sizes in the irrigation tubing 10. Any mechanical sliding mechanism known in the art may be utilized with the present disclosure.

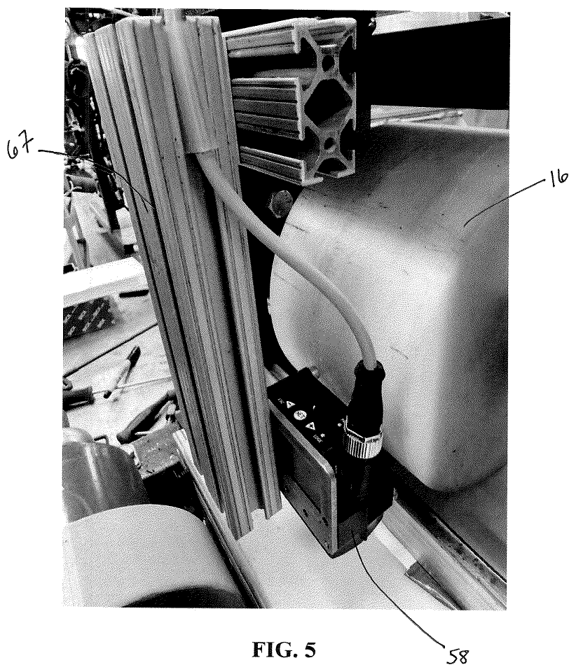

FIG. 5 shows an example of a sensor 58 contemplated for use with the hole insertion device 100. The hole insertion device 100 may have one or more edge sensors 58 to measure and monitor the position of the edge of the irrigation tubing 10 as holes are continuously punched therein. The edge sensor 58 can precisely locate the edge of the irrigation tubing 10 to make on-the-fly carriage adjustments to precisely control hole size. In some embodiments, the hole insertion device 100 can include two edge sensors 58—one located on each side of the guide roller 16. The sensor 58 can be supported on a stand 67 attached to the rotary die assembly 26. However, the sensor 58 should be located adjacent to the edge of the irrigation tubing 10 as it enters and exits the rotary die assembly 26.

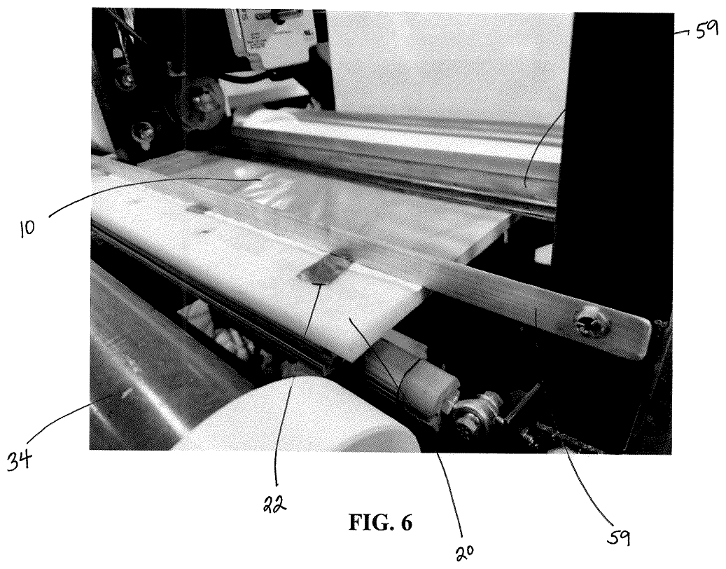

FIG. 6 shows an example of an additional guide rail 59 that can be used with the hole insertion device 100. The guide rail 59 shown in FIG. 6 can be positioned along the base 20 to hold the irrigation tubing 10 closer to the surface of the base 20 and keep it flat as the irrigation tubing 10 moves through the hole insertion device 100. This allows for a more accurate cut along the irrigation tubing 10. The guide rail 59 extends laterally across the base 20 and remains flush therewith such that the guide rail 59 is able to hold the irrigation tubing 10 in close proximity to the base 20. In the illustrated embodiment, two guide rails 59 are positioned on the base 20—one at the front and one at the rear. Though, as will be appreciated by those skilled in the art, any number of guide rails 59 may be used depending on the size of the base 20.

The hole insertion device 100 is configured to insert holes in the irrigation tubing 10 in a continuous manner. In this embodiment, the hole insertion device 100 includes a drive member 31 for powering continuous rotation of the rotary die assembly 26 and for unwinding the irrigation tubing 10 from the spiral pipe roll 12. In some embodiments, the drive member 31 may be an electrical motor controlled by a controller 33. When holes are desired, the drive member 31, for instance, the motor, can be activated by the controller. The motor can be configured to unroll the irrigation tubing 10 and rotate the rotary die assembly 26 at a speed substantially equal to the speed the irrigation tubing 10 passes through the device 100. In this embodiment, the controller 33 can determine the timing and rate at which the drive member 31, for instance, the motor, should accelerate for the hole punch die 36 to intersect the irrigation tubing 10 as it passes through the device 100 and make consistently spaced holes according to the desired prescription, such as a specific CHS punch list.

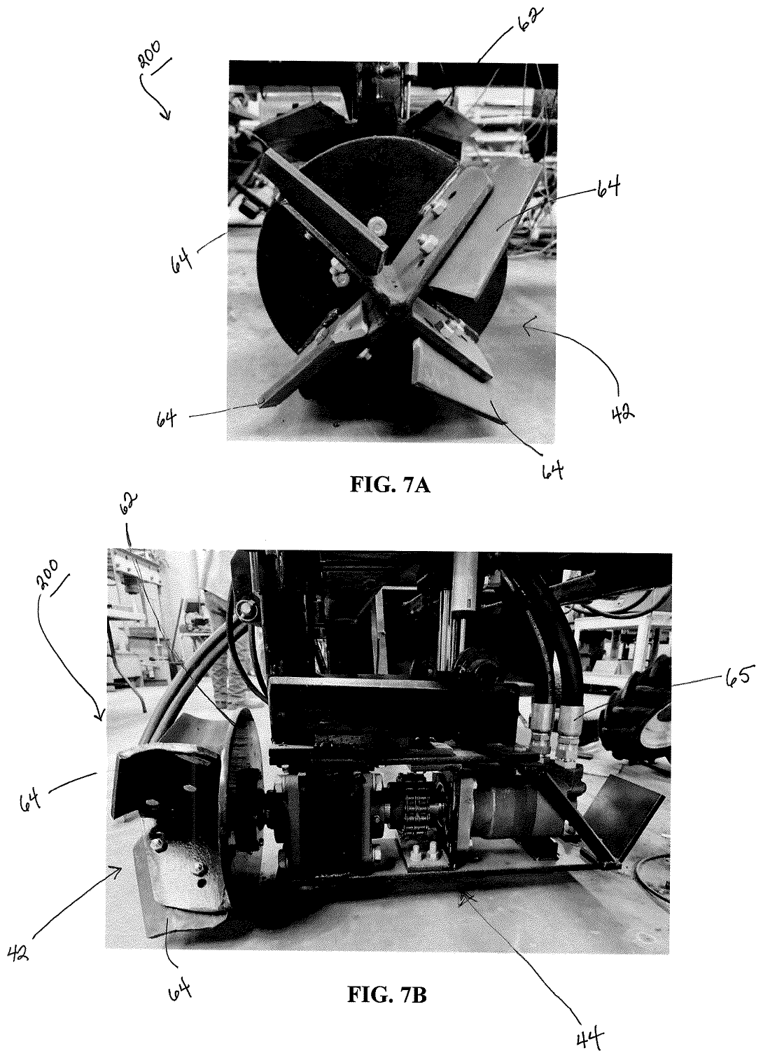

FIGS. 7A and 7B illustrate a placement device 200 according to one embodiment of the present disclosure. The placement device 200 is configured for laying the irrigation tubing 10 in the field after the holes have been formed therein. The placement device 200 is configured to create a curved trough in the tubing pathway, for example, the soil, and lay the punched tubing 10 therein. The placement device 200 is designed to control tubing behavior during inflation and prevent the irrigation tubing from twisting or rolling, which in turn, maintains the holes in the correct orientation to deliver water into each furrow as desired. The placement device 200 is also configured to utilize the removed loose soil from the trough by placing it on top of the uninflated tubing to hold it in the desired position prior to charging it with water. In one embodiment, the placement device 200 can be operatively connected to the hole insertion device 100 so that both devices can be used together out in the field. In further embodiments, the placement device 200 and the hole insertion device 100 may be used separately.

As shown in FIGS. 7A and 7B, the placement device 200 includes a rotary cutting device 42 configured to cut a trough in the soil. In one embodiment, the rotary cutting device 42 may be a rotary ditcher head. The rotary cutting device 42 may include a rotor 62 and a plurality of blades 64 supported on the rotor 62 for cutting into the soil as the rotor 62 is rotated. The blades 64 are suited for cutting into the soil and for subsequently throwing the soil generally tangentially to the rotating rotor body. As will be discussed in more detail below, the width of the trough can be adjusted by repositioning the blades 64 on the rotary cutting device 42 or by replacing the blades with those of a different length. The trough created by the rotary cutting device 42 is substantially curved so as to prevent the tubing from twisting or rolling as it inflates, keeping the pre-punched holes oriented in the correct direction relative to the desired discharge into the furrows. The curved trough or depression in the soil mirrors the curvature of the inflated irrigation tubing, which provides greater surface area contact between the tubing and the soil and helps cradle the tubing to prevent it from twisting and rolling during inflation. The size, depth, positioning relative to the tubing, and other factors of the trough are customizable relative to the tubing diameter and soil characteristics including soil type, elevation, and the like.

In one embodiment, the rotary cutting device 42 is hydraulically driven. In this embodiment, a hydraulic motor 44 is coupled to the rotary cutting device 42. The hydraulic motor 44 may include a hydraulic input 65 which includes quick couplers for ready connection to the hydraulic supply lines of the transport implement to which it is attached while permitting ready separation of the hydraulic motor from hydraulic supply of the implement when detaching the rotary cutting device 42 from the implement.

The rotary cutting device 42 can be regulated with the hydraulic motor 44. That is, the rotary cutting device 42 can be adjusted to vary the dimensions of the trough. In one embodiment, the width of the trough can be varied by changing the size of the rotary cutting device 42 or the blades 64 positioned thereon. In another embodiment, with the use of the hydraulic motor 44, the rotary cutting device 42 can be adjusted on two axes—horizontal and vertical—to vary the depth and horizontal position of the trough. For example, in one embodiment, the hydraulic motor 44 can adjust the rotary cutting device 42 in a vertical direction to create a deeper or shallower trough depending on the elevation changes in the field. In another embodiment, the hydraulic motor 44 can adjust the rotary cutting device 42 in a horizontal direction to control irrigation piping placement and hole orientation depending on the location within the field. By adjusting the position of the trough relative to the tubing, the amount of tubing placed into the trough during inflation can be adjusted to control hole orientation. For example, if the central axes of the trough and the tubing are aligned while laying, the tubing will inflate in place with no movement and the holes will be oriented horizontally. If, however, the central axis of the trough is offset from the tubing during laying, the tubing will inflate into the trough, causing the hole trajectory to change. This allows the water to arch into the furrows and potentially prevent soil erosion due to high-velocity water discharge directed at the soil surface. Hence, the placement device 200 can control the behavior of the tubing during irrigation events and reduce or eliminate changes in internal pipe pressures due to elevation changes encountered from field conditions.

In some embodiments, the loose soil removed by the placement device 200 can be collected and redirected onto the tubing as it is deployed into the trough to hold it in the desired position until the tubing is filled during an irrigation event. In this embodiment, the blades 64 on the rotary cutting device 42 are configured to throw the soil generally tangentially to the rotating rotor body such that the soil is placed along the edges of the tubing. The loose soil is then deposited onto the tubing by a device such as a disc blade, which, in turn, creates resistance to being dislodged as the tubing is laid the field. This allows the tubing to remain in the desired orientation and position until it is charged during the first irrigation cycle, resulting in correct hole orientation relative to the row.

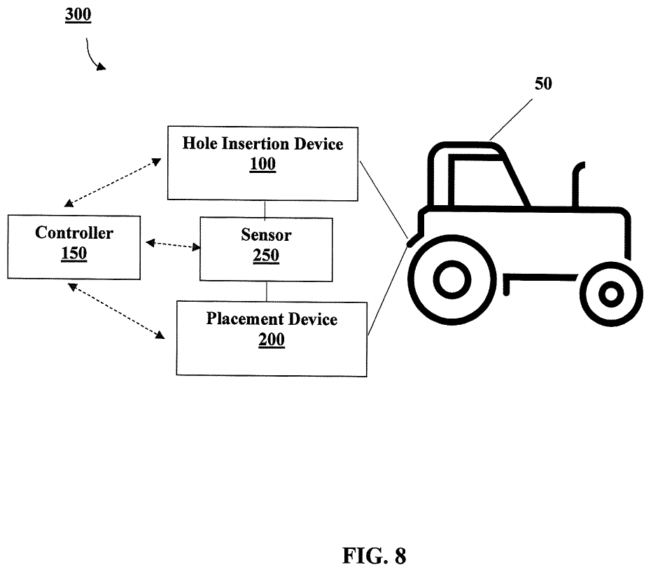

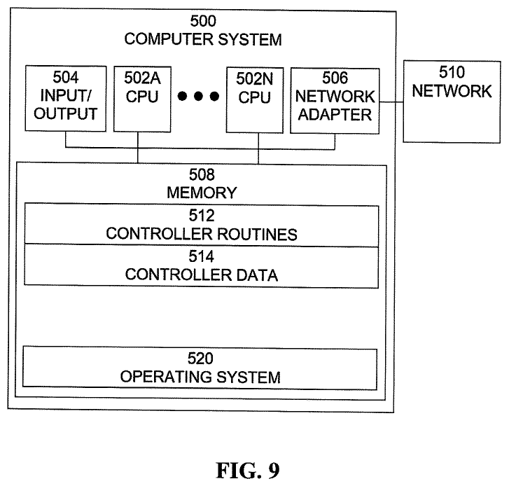

FIG. 8 shows a schematic diagram of a system 300 for selectively inserting holes in the irrigation tubing 10 using the hole insertion device 100 and laying the punched irrigation tubing 10 with the placement device 200. As shown in FIG. 8, the hole insertion device 100 and the placement device 200 are attached to a transport implement 50. The transport implement 50 may be any type of machinery capable of maneuvering or traversing through agricultural fields. In the illustrated embodiment, the transport implement 50 is shown as a tractor. However, the transport implement 50 may be an all-terrain vehicle (ATV), an all-terrain utility vehicle (ATU), a trailer, a truck, or other type of farm equipment. The hole insertion device 100 and the placement device 200 may be attached to the transport implement 50 using any mechanism known in the art, for instance, by a hitch or other attachment mechanism.

In the system of the present disclosure, the hole insertion device 100 and the placement device 200 are communicatively coupled to a controller 150. The controller 150 is configured to receive real-time data from one or more sensors 250. In one embodiment, the controller 150 may be configured to receive, for instance, location data from a global positioning system (GPS) positioned on the transport implement 50, data from Computerized Hole Section (CHS) prescriptions, and/or groundspeed data from the transport implement 50, and provide the data to both the hole insertion device 100 and the placement device 200. The data is used by the hole insertion device 100 to precisely locate and size the holes in accordance with CHS prescriptions. The placement device 200 can use the data to accurately create and locate the trough based on elevation and location changes in the field for deployment of the tubing. Moreover, the groundspeed data can be used by the hole insertion device 100 to set row spacing, provide the first trigger (punch) event, and determine when to punch the next hole independent of the GPS.

In some embodiments, the controller 150 includes a computing device 500, as shown in FIG. 9. The controller 150 may also be communicatively coupled to the computing device 500. The computing device 500 may be implemented using one or more programmed general-purpose computer systems, such as embedded processors, systems on a chip, personal computers, workstations, server systems, and minicomputers or mainframe computers, or in distributed, networked computing environments. The computing device 500 may include one or more processors (CPUs) 502A-502N, input/output circuitry 504, network adapter 506, and memory 508. CPUs 502A-502N execute program instructions to carry out the functions of the present systems and methods. Typically, CPUs 502A-502N are one or more microprocessors, such as an INTEL CORE® processor.

Input/output circuitry 504 provides the capability to input data to, or output data from, the computing device 500. For example, input/output circuitry 504 may include input devices, such as a graphical user interface, keyboards, mice, touchpads, trackballs, scanners, and analog to digital converters; output devices, such as video adapters, monitors, and printers; and input/output devices, such as modems.

Network adapter 506 interfaces the computing device 500 with a network 510. Network 510 may be any public or proprietary data network, such as LAN and/or WAN (for example, the Internet). Memory 508 stores program instructions that are executed by, and data that are used and processed by, CPU 502 to perform the functions of the computing device 500. Memory 508 may include, for example, electronic memory devices, such as random-access memory (RAM), read-only memory (ROM), programmable read-only memory (PROM), electrically erasable programmable read-only memory (EEPROM), and flash memory, and electro-mechanical memory, which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, or Serial Advanced Technology Attachment (SATA), or a variation or enhancement thereof, or a fiber channel-arbitrated loop (FC-AL) interface.

Memory 508 may include controller routines 512, controller data 514, and operating system 520. Controller routines 512 may include software routines to perform processing to implement one or more controllers. Controller data 514 may include data needed by controller routines 512 to perform processing. For example, controller routines 512 may include software for analyzing incoming data.

In one embodiment, the controller routines 512 may include software for analyzing incoming data obtained from a CHS plan. The controller routines 512 are configured to analyze CHS plans formulated using any type of program known to those of ordinary skill in the art, such as PHAUCET or Pipe Planner. In one embodiment, the controller routines 512 are configured to analyze the incoming data from the CHS plan and, in response, continuously adjust the hole size on the hole insertion device 100 such that the holes punched in the irrigation tubing 10 match the hole sizes prescribed by the CHS plan. In one embodiment, the applicable CHS plan may be loaded into the memory 508 of the computing device 500. In another embodiment, the one or more sensors 250, such as GPS, may automatically identify the appropriate CHS plan based on location of the field. In still another embodiment, the applicable CHS plan may be sent to the computing device 500 over the network 510.

In another embodiment, the controller routines 512 are configured to analyze incoming data obtained from one or more sensors 250 on the transport implement 50. For instance, in this embodiment, the controller routines 512 are configured to analyze real-time groundspeed data obtained from one or more sensors 250 on the transport implement 50 and, in response, adjust the row spacing on the hole insertion device 100 and/or the timing of the hole punching performed by the hole insertion device 100. In still another embodiment, the controller routines 512 are configured to analyze incoming data obtained from one or more edge sensors 58 positioned on the hole insertion device 100 and, in response, adjust the positioning of the irrigation tubing 10 as it is fed through the hole insertion device 100.

In another embodiment, the controller routines 512 may include software for analyzing incoming data obtained from GPS. In this embodiment, the controller routines 512 are configured to analyze real-time location and elevation data obtained from the GPS and, in response, continuously adjust the location of the holes to be punched as the irrigation tubing 10 proceeds through the hole insertion device 100. The real-time location and elevation data can include GPS coordinates (for example, latitude and longitude coordinates), a speed of the transport implement 50, a time, and/or an elevation of a specific geographical location. In some embodiments, the GPS updates the location and elevation data at a predetermined frequency. For example, the GPS can provide real-time data such that the GPS updates about once per second. In another embodiment, the GPS may update at least about ten times per second. In still another embodiment, the GPS may update at least about one hundred times per second.

In still another embodiment, the controller routines 512 are configured to analyze real-time location and elevation data obtained from the one or more sensors, such as the GPS, and, in response, adjust the positioning and placement of the rotary cutting device 42. In this embodiment, the dimensions of the trough (for instance, the horizontal position and/or depth) can be adjusted based on location and elevation data. The system 300 also allows for rapid in-cab adjustments of the rotary cutting device 42 using the hydraulic motor 44 to adjust to certain field conditions.

By automating the hole punch process and incorporating it into the laying of lay-flat irrigation tubing, the system 300 of the present disclosure streamlines the process into a single-pass operation, reducing both the time needed to begin irrigation activities, the labor required to perform the process, and lessen the potential for errors and omissions that could negatively affect irrigation efficacy and water usage. Incorporating the ability to utilize CHS prescriptions in the system 300 allows for the optimization of hole prescriptions for every hole, instead of a series of holes, and allows for the precise delivery and application of irrigation water across the field. The combination of these technologies creates an efficient, single-pass implement capable of precise hole sizing and location and streamlines the process of utilizing lay-flat irrigation tubing to meet water needs for improved crop efficiencies and yields.

The systems and apparatuses described and claimed herein are not to be limited in scope by the specific embodiments herein disclosed, since these embodiments are intended as illustrations of several aspects of the disclosure. Any equivalent embodiments are intended to be within the scope of this disclosure. Indeed, various modifications of the apparatuses and systems in addition to those shown and described herein will become apparent to those skilled in the art from the foregoing description. For example, while the systems and apparatuses have been described herein for use with furrow irrigation systems, the present invention technology could be applied to any agricultural system that would benefit from infinitely variable application, from irrigation to fertilization to seed dispersal. Such modifications are also intended to fall within the scope of the disclosure. All patents and patent applications cited in the foregoing text are expressly incorporated herein by reference in their entirety. Any section headings herein are provided only for consistency with the suggestions of 37 C.F.R. § 1.77 or otherwise to provide organizational queues. These headings shall not limit or characterize the invention(s) set forth herein.

What is claimed is:

1. A device for punching holes in irrigation tubing, comprising:
a die assembly comprising a top roller and a bottom roller, each roller having spaced parallel axes of rotation,
a die mounted on the bottom roller, wherein the die is circular or semi-circular and configured to punch a circular or semi-circular hole in the irrigation tubing, and
a drive member for powering continuous rotation of the bottom roller.

2. The device of claim 1, further comprising a surface positioned above the bottom roller, the surface comprising an opening vertically aligned with the die.

3. The device of claim 2, further comprising a carriage device operatively connected to the die assembly and configured to horizontally slide the bottom roller to varying distances under the opening.

4. The device of claim 1, wherein the die is circular, and the circular hole has a diameter of about 13/16 inch to about 7 inches.

5. The device of claim 1, wherein the drive member is an electrical motor controlled by a controller.

6. A device for punching holes in irrigation tubing, comprising:
a frame comprising a mount attached thereto, the mount configured to support a roll of wound irrigation tubing;
a die assembly attached to the frame, the die assembly comprising a top roller and a bottom roller, each roller having spaced parallel axes of rotation, and a die mounted on the bottom roller, wherein the die is shaped as a circle or semi-circle and configured to punch a circular or semi-circular hole in a folded seam of the irrigation tubing;
a plurality of rollers positioned on each side of the die assembly and extending laterally across the frame; and
a drive member for powering continuous rotation of the bottom roller.

7. The device of claim 6, wherein the die assembly further comprises a surface positioned above the bottom roller, the surface comprising an opening vertically aligned with the die.

8. The device of claim 7, further comprising a slidable carriage device operatively connected to the die assembly and configured to horizontally slide the bottom roller to varying distances under the opening.

9. The device of claim 6, further comprising a sensor operatively connected to the die assembly and configured to measure and monitor an edge of the irrigation tubing as holes are continuously punched therein.

10. The device of claim 6, wherein at least one roller comprises a first guide roller attached thereto at a first end and a second guide roller attached thereto at a second end.

11. The device of claim 7, wherein the surface further comprises a guide rail extending laterally across the surface and configured to flatten the irrigation tubing against the surface.

12. A system for punching holes in irrigation tubing and laying the punched irrigation tubing, comprising:
the device for punching holes in irrigation tubing according to claim 1;
a placement device for laying the punched irrigation tubing comprising a rotary cutting device operatively connected to a hydraulic motor, the rotary cutting device comprising a rotor having a plurality of blades supported thereon, wherein the rotary cutting device is configured to cut a substantially curved trough for placement of the punched irrigation tubing;
at least one sensor positioned in proximity to the device for punching holes and the placement device; and
a controller communicatively coupled to the device for punching holes, the placement device, and the at least one sensor, wherein the controller is configured to perform at least one of the following:
receive and communicate data from a Computerized Hole Section (CHS) prescription to the device for punching holes and, in response, adjust the size of a hole to be punched in the irrigation tubing,
receive and communicate data from the at least one sensor to the device for punching holes and, in response, adjust a location of a hole to be punched in the irrigation tubing, or
receive and communicate data from the at least one sensor to the placement device and, in response, adjust at least one or both of a horizontal position and a vertical position of the rotary cutting device.

13. The system of claim 12, further comprising a transport implement having the device for punching holes and the placement device attached thereto.

14. The system of claim 12, wherein the at least one sensor comprises a global positioning system (GPS) and the controller is configured to receive data from the GPS.

15. The system of claim 12, wherein the controller comprises a computing device having a memory.

16. The system of claim 15, wherein the memory stores the data from the CHS prescription.

17. The system of claim 12, wherein the controller is configured to receive and communicate data from the at least one sensor to the device for punching holes, and in response, adjust the timing of the holes to be punched in the irrigation tubing.

18. The system of claim 12, wherein the rotary cutting device is a rotary ditcher head.
